(19) United States
(12) Patent Application Publication
(10) Pub. No.: US 2019/0145861 A1
(43) Pub. Date: May 16, 2019

(54) A SYSTEM AND A METHOD FOR TESTING FUNCTIONALITIES OF A VEHICLE

(71) Applicant: Scania CV AB, Södertälje (SE)

(72) Inventors: Milivoj PERSSON, Stockholm (SE); Simon FAGERHOLM, Farsta (SE)

(73) Assignee: Scania CV AB, Södertälje (SE)

(21) Appl. No.: 16/306,604

(22) PCT Filed: Jun. 7, 2017
(86) PCT No.: PCT/SE2017/050601

§ 371 Date: Dec. 3, 2018

(30) Foreign Application Priority Data
Jun. 7, 2016 (SE) 1650789-9

(51) Int. Cl. G01M 17/007; G07C 5/08; H04L 12/40

(52) U.S. Cl. CPC G01M 17/007; G07C 5/0825; H04L 2012/40273; H04L 12/40; H04L 2012/40215; G07C 5/0841

(57) ABSTRACT

A system for testing functionalities of a vehicle while driving the vehicle having a message-based bus network topology comprises a software server configured to be connected to the bus and to take vehicle sub-system information therefrom and interpret it as output from a timed automaton. The system also comprises at least one client in the form of an executable test script written in a programming language and configured to from the server subscribe specific vehicle sub-system information to be used by a test assessment oracle of the test script for assessing a particular function or sub-function of the vehicle.

### CROSS-REFERENCE TO RELATED APPLICATIONS

This application is a national stage application (filed under 35 § U.S.C. 371) of PCT/SE2017/050601, filed Jun. 7, 2017 of the same title, which, in turn, claims priority to Swedish Application No. 1650789-9 filed Jun. 7, 2016; the contents of each of which are hereby incorporated by reference.

### FIELD OF THE INVENTION

The present invention relates to a system for testing functionalities of a distributed embedded system in the form of a vehicle as well as a method for carrying out such testing.

### BACKGROUND OF THE INVENTION

The number of new trucks registered is steadily increasing, and at the same time all vehicles experience an increase of electrification and digitalization when manufacturers realize more functionality and value through the use of microcontrollers and computers. Additionally, the consumers demand more modularity which leads to the fact that all newly produced vehicles could today, in theory, be different from the rest of the vehicle line-up. This means that the designers had to enable such an enormous variation, but the same goes for the people responsible for quality assurance. With a huge amount of manufactured vehicles, all with increased complexity, and all being virtually different from one another, this quality assurance task becomes exhausting.

This together results in an incitement to try to computerize the necessary tests to be carried out for checking that particular functions or sub-functions of the vehicle work as required for a proper operation of the vehicle with respect to safety and/or to meet law requirements. Thus, it would be attractive to let a computer at least partially replace a human when carrying out such testing, since a computer works at a much faster rate, so that it would be possible to have richer test cases that perform more complex assessments than in the case of manually performing the tests.

When a requirement involved in a functionality of the vehicle is to be tested at system level the following three environments are offered: “software-in-the-loop” (SIL), “hardware-in-the-loop” (HIL) and in-vehicle environment. SIL is an environment where the whole truck is simulated, run as a software program, and a world in which the truck drives around in is simulated as well. This means that it's only the software that is truly tested and this can be performed directly on a computer such as a laptop. HIL is very similar to SIL, but now real hardware of some of the different modules is tested towards the simulated world. This “tricks” the hardware to believe that it is driving in real-world conditions. The last test environment is the one to which the present invention is directed, the in-vehicle testing environment. In this environment a completely assembled vehicle would be used as a testing vehicle and be driven around a test track or on public roads just like an end-user would. It is evident that this testing environment is the most attractive one, since if it is important to see how the environment and the hardware interact with each other then it is more or less necessary to carry out in-vehicle tests. The same goes for safety critical tests, which have to be verified that they actually work in a real vehicle.

It would for that sake be favorable to provide an automatic in-vehicle testing tool, which means that it is a software program that can connect to a truck and automatically perform assessments and automatically generate verdicts to the system tests that are performed on vehicles. Possible benefit would be time savings as these type of tests are otherwise performed manually which is time consuming, and reproducability, besides which it would become more obvious what has actually been tested compared with the case with complete manual execution.

US 2010/0079301 A1 discloses a system and a method of testing a machine which may be used for testing functionalities of a vehicle, which however requires that the driver of the vehicle carries out actions according to a predetermined script and provides the test system with inputs asked for, whereupon the test system checks whether a test condition is fulfilled and may be verified. However, a plurality of tests may not be run in parallel at the same time as it is necessary to give the driver information about the actions to be taken.

### SUMMARY OF THE INVENTION

The object of the present invention is to provide a system and a method for testing functionalities of a distributed embedded system in the form of a vehicle by driving the vehicle being improved in at least some aspect with respect to such systems and methods already known.

This object is with respect to the system obtained by providing a system with the features listed in the appended patent claim 1.

Thus, the invention is based on utilizing the presence of a message-based bus network topology to which different sub-systems of the vehicle are connected for publishing and reading information relating to the status of these sub-systems, such as a CAN-bus, and establishing a connection thereto to be maintained during the driving of the vehicle for obtaining an automatic in-vehicle testing tool influencing neither the vehicle nor the driver when testing functionalities of the vehicle during driving of the vehicle.

By having a software server configured to be connected to said bus and to take said sub-system information therefrom and interpret it as output from a timed automaton the idea to have a piece of computer software monitor bus-traffic and perform test assessment on this information automatically may be achieved by then also providing the system with at least one client in the form of an executable test script written in a programming language and configured to from said server subscribe specific vehicle sub-system information to be used by a test assessment oracle of the test script for assessing a particular function or sub-function of the vehicle. Furthermore, the client is subscribing to be updated by the server of a change of said specific vehicle sub-system information and the test script is configured to initiate said test assessment oracle to make an assessment of said particular function or sub-function of the vehicle upon said update of said specific information subscribed so as to deliver a test result by giving a final verdict of said particular function or sub-function of the vehicle. This means that in the case of more than one client each client will connect and subscribe to the server and when running, that is when the test driver drives the vehicle to be tested on public roads or on a test track, the server will, in turn, update each of its clients when the trucks state changes. However, only the clients that subscribe to that particular change will be updated, leaving the other clients dormant and thus reducing the CPU load. When a test script or test step has been given a final verdict it can be detached and will not run its assessment anymore relieving processor power for other tasks.

The advantages of the invention with respect to manual in-vehicle testing are many. Instead of relying on the drivers' sensation, quantifiable signals are the basis for the verdicts resulting in the possibility to have more precise criteria. Furthermore, the drivers do not always perform the test steps as they are intended to be performed, as they interpret the natural language in the test specification for each test step. This issue is removed when a test step is made by an executable test script written in a programming language. The purely monitoring architecture of the system according to the invention makes injection of faults to the vehicle tested by the testing procedure improbable.

According to an embodiment of the invention the system comprises a unit configured to store test results delivered by the test script during driving of the vehicle to be viewed at a later moment. Moreover, the driver has not to examine the verdict during driving, although that may be possible, but may wait to do this after having come to a full stop of the vehicle then being in a safe state.

According to another embodiment of the invention the system comprises a member configured to send test results to a graphical user interface so as to be displayed to the driver of the vehicle. This makes it possible for the driver to see and react upon the test results during the driving of the vehicle would that comply with safety requirements existing. Otherwise the driver or other persons may use this option after the testing tour of the vehicle has been completed.

According to another embodiment of the invention the system comprises a plurality of said clients in the form of different executable test scripts each being a separate test step being configured to subscribe different said specific vehicle sub-system information and by carrying out said test assessment oracle thereof together forming a test case assessing if the vehicle functionality tested conforms to its requirements. Accordingly, the invention enables carrying out a plurality of test steps in parallel and in any suitable order depending upon which specific information is subscribed by the respective test script and when a change thereof occurs causing an updating of the test script initiating the test assessment oracle of the test script to make an assessment of the particular function or sub-function of the vehicle associated with that test script.

According to another embodiment of the invention said server is associated with hardware and software for converting electrical signals taken from said bus into digital signals to be sent to said at least one client. This constitutes one suitable of many ways to accomplish a system according to the present invention.

According to another embodiment of the invention the system is a testing tool included in one single mobile computer, such as a PC. This means that the software server and its client/clients will communicate over the computers' internal communication channels. This allows the tester to bring a single piece of hardware to both run the automated in-vehicle testing tool, but also other test related software, such as logging software, which may be favorable with respect to simplicity and costs.

The object of the invention is with respect to the method obtained by providing a method for testing functionalities of a distributed embedded system in the form of a vehicle while driving the vehicle with the steps listed in the appended independent method claim. The properties and advantages of such a method and the embodiments thereof defined in the appended dependent method claims appear clearly from the above-discussion of the test system according to the invention.

The invention also relates to a computer program and a computer-readable medium according to the appended claims directed to a computer program and a computer-readable medium, respectively.

Further advantages as well as advantageous features of the invention will appear form the description following below.

### BRIEF DESCRIPTION OF THE DRAWINGS

With reference to the appended drawings, below follows a specific description of an embodiment of the invention cited as an example.

In the drawings:

FIG. 1 illustrates very schematically the architecture of a test system according to an embodiment of the invention in connection with a vehicle the functionalities of which are to be tested,

FIG. 2 illustrates very schematically the function of a part of the system shown in FIG. 1, and

FIG. 3 is a flow chart illustrating the steps carried out in a method according to an embodiment of the invention.

### DETAILED DESCRIPTION OF THE INVENTION

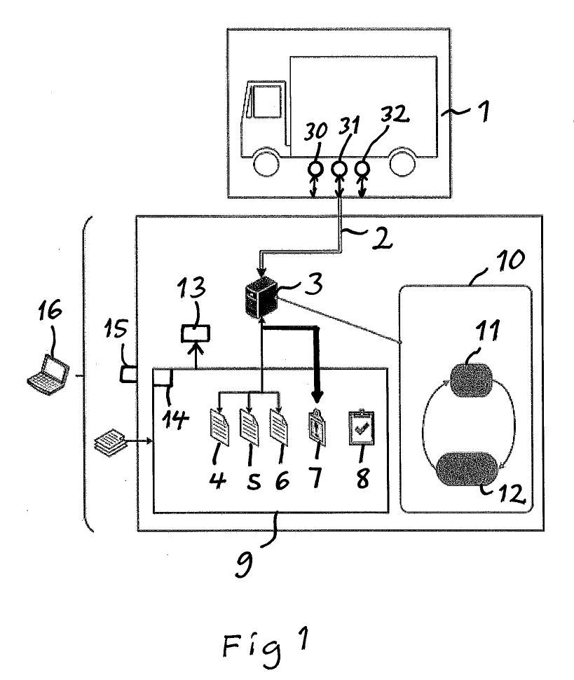

FIG. 1 illustrates the architecture of a testing tool for testing functionalities of a distributed embedded system in the form of a vehicle 1, here a truck. The truck can be seen as different sub-systems 30-32 each performing their respective function. Such sub-systems may be the engine, the transmission, the brakes etcetera of the vehicle. In order for these sub-systems to perform precise and synchronized tasks together they are forced to communicate with each other, which is done by the use of a message-based bus 2 network topology in the form of a Controller Area Network bus (CAN-bus). This allows each sub-system to publish information on the bus and also read information from the bus.

The system comprises a software server 3 configured to be physically connected to the bus 2 and to take said sub-system information therefrom and interpret it as output from a timed automaton. Clients 4-8 each in the form of an executable test script written in a programming language are configured to from the server 3 subscribe specific vehicle sub-system information to be used by a test assessment oracle of the test script for assessing a particular function or sub-function of the vehicle. The test scripts are here written in Python code, but other languages are also conceivable. Thus, the clients 4-8 may be defined as single test steps assessing a particular function or sub-function. A group of these test steps are defined as a test case assessing if the system functionality conforms to its requirements. All the test cases make up the total test suite 9. Each client will connect and subscribe to the server and when running, that is when the test driver drives the vehicle 1 to be tested on public roads or on a test track, the server 3 will update each of its clients 4-8 when the trucks state changes. However, only the clients that subscribe to that particular change will be updated, leaving the other clients dormant and thus reducing the CPU load. This is shown in FIG. 1 as a thicker line to the ongoing test step of the client 7. When a test step has been given a final verdict it can be detached and will not run its assessment anymore, which here is the case for the test step of the client 8. A specific vehicle sub-system information may be the status of brakes of the vehicle, which may be active (braking) or inactive (not braking) and changes of information relating thereto will be sent from the server 3 to the client or clients subscribing to be updated by the server of such changes. This is illustrated by the box 10 with 11 standing for braking and 12 for not braking.

The system further comprises a unit 13 configured to store test results delivered by the test scripts during driving of the vehicle to be viewed at a later moment as well as a member 14 configured to send the test results to a graphical user interface 15 so as to be displayed to the driver of the vehicle.

It is here illustrated how the testing tool may be included in one single mobile computer, such as a PC 16 to be connected to said message-based bus 2 network topology of the vehicle 1 by suitable means, such as a connector.

By way of example it will now be described how to proceed for carrying out a test of a functionality to be present in the vehicle, which considers the requirement for the drive line system in heavy trucks governed by law and legislation stating that “the maximum permissible speed for heavy trucks is 90 km/h”. The testable statement may then be: no torque applied if the vehicle is at a speed greater than 90 km/h. The first thing to do in order to run an automated in-vehicle test for testing this functionality is to provide the clients in the form of test-scripts to be used for this. Test steps in natural language are for this converted into Python scripts. After all the desired test scripts have been written the test driver selects the applicable test scripts and include these to the tool before launching it. The test driver will then physically connect the testing tool to the vehicles CAN-bus 2 and turn on the ignition to wake up the vehicle's electronic systems. When the CAN-bus is active, the driver can start the third party CAN interfaces in order to monitor the traffic on the bus and forward this to the automated in-vehicle testing tool. Lastly, the test driver launch the automated in-vehicle testing tool which will set up the different signal subscriptions and start executing all the test scripts automatically.

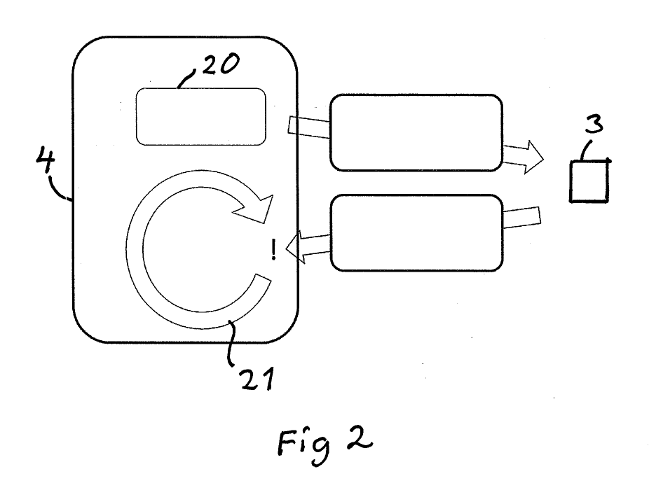

References is now also made to FIG. 2 showing how each test script 4 is composed of two components, a set up component 20 and an update loop component 21. During the set up the server 3 retrieves the test scripts set of monitored signals. This is done in order for the server to know when to update the test script and what signals it needs in order to conduct its assessment.

After all test scripts have provided the information listed in the set up component 20 the update loop 21 becomes active. This is the test assessment loop or oracle that is initiated when the server updates the test scripts with a new vehicle state according to the scripts' subscription. After the assessment has been performed the test script becomes dormant until next update arrives from the server.

How this is implemented at the code level may be illustrated by the following test script for the test mentioned above

monitored_signals =

[ENGINE_SENSOR−>ENGINE_TORQUE, ...]

guard = SPEED_SENSOR−>VEHICLE_SPEED > 90.0
if not initialized:

do initializing if necessary...

return (monitored_signals, guard)

This is an example illustrated in pseudocode of how the set up component of a test script can be written. It is here stated that the signals needed in order to perform the test step are in this case signals informing about the “engine torque”. Apart from the monitored signal “engine torque” there is another signal that is important for the test script to be updated on and this is the signal that is contained in the guard variable. This is the guard that is used in the “Independent Guarded Assertion” strategy to be considered. This is the precondition that must be fulfilled before the test assessment can be conducted. This is also sent to the server in order to add it to the list of signals that will cause the test script to be updated in the “update loop” phase.

After all necessary signals and guards have been defined additional initialization can be performed before going into the “update loop”. This could be defining the maximum number of times the test script should run or any other stated behavior for the test script. Finally, the monitored signals together with the guard are sent to the server.

The guard will terminate the script with a “not tested” result if the vehicle speed has never reached 90 km/h during the testing procedure. If the guard instead will be satisfied the test script will perform its assessments, evaluating if the truck conforms to the regulations that no torque is applied when going faster than 90 km/h. When the assessment is finished a result of either “failed” or “not failed” is given. The reason why no “passed” result exists is that a requirement such as this must uphold for every situation and only performing it once is not enough to simply give it a “passed” label. Instead it is more reasonable to state that during the test execution the vehicle did not enter a faulty operation, but it is impossible to state with certainty that this may never occur. The benefits, especially with respect to safety, of automatic in-vehicle testing at these high speeds on public roads with traffic compared to tests carried out manually are obvious.

Lastly, the result may be sent to a graphical user interface to be displayed to the test driver.

In addition to the verdicts “not tested”, “failed” and “not failed” the rest of possible verdicts that can be generated with the automatic in-vehicle testing tool are “passed”, “not passed” and “inconclusive”.

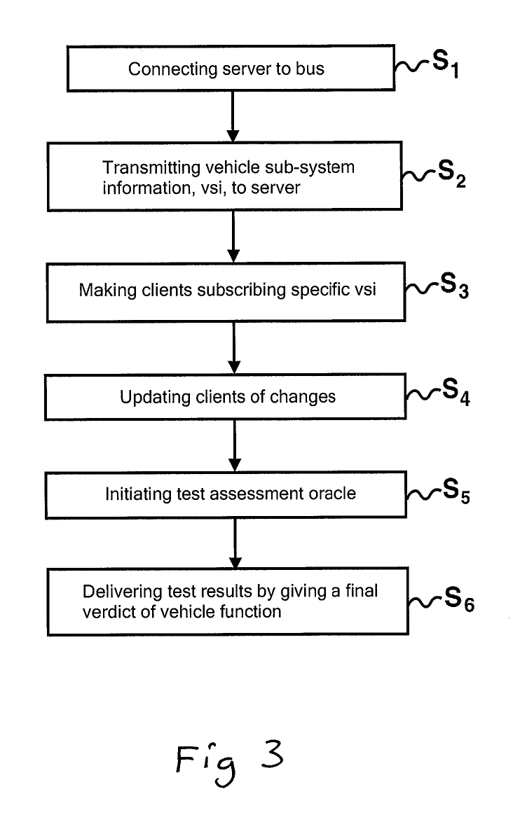

FIG. 3 illustrates a flow chart of a method according to an embodiment of the present invention. The method is started with a step S₁ of connecting server to bus (message-based bus network topology, such as a CAN-bus). This is followed by a step S₂ of transmitting vehicle sub-system information to server, whereupon in a step S₃ clients are made subscribing specific vehicle sub-system information. Clients are then in a step S₄ updated of changes of said specific vehicle sub-system information. Test assessment oracle is then initiated in step S₅ followed by delivering test result by giving a final verdict of vehicle function in a step S₆.

The invention is directed to such testing of any type of vehicle, but especially wheeled vehicles and in particular heavy wheeled vehicles, such as trucks, which is the reason for directing this disclosure mainly to testing of such vehicles for illuminating the problems to be solved by the invention and how these are solved without for that sake restricting the invention to the testing of such vehicles.

The invention is of course in no way restricted to the embodiments described above, since many possibilities for modifications thereof are likely to be obvious to one skilled in the art without having to deviate from the scope of invention defined in the appended claims.

Another message-based bus network topology than CAN may be used, such as Flexray. Although advantageous, it is not a requirement to have software server, clients, data-storing unit, graphical interface and a display unit included in one single device, such as a PC, but these may be separated into two or more devices.

The system according to the invention may of course also be used to test functionalities of other types of distributed embedded systems than a vehicle.

It would also be possible to record all data from said bus during driving of the vehicle and then later send this data in the same order and timing as recorded to the software server to be communicated to the clients subscribing thereto.

1. A system for testing functionalities of a distributed embedded system in the form of a vehicle while driving the vehicle having a message-based bus network topology to which different sub-systems of the vehicle are connected for publishing and reading information relating to the status of these sub-systems, the system comprising
a software server configured to be connected to said bus and to take said sub-system information therefrom and interpret it as output from a timed automaton; and
at least one client in the form of an executable test script written in a programming language and configured to from said server subscribe specific vehicle sub-system information to be used by a test assessment oracle of the test script for assessing a particular function or sub-function of the vehicle,
wherein said client is subscribing to be updated by the server of a change of said specific vehicle sub-system information, and
wherein the test script is configured to initiate said test assessment oracle to make an assessment of said particular function or sub-function of the vehicle upon a said update of a said specific information subscribed so as to deliver a test result by giving a final verdict of said particular function or sub-function of the vehicle.

2. A system according to claim 1, further comprising a unit configured to store test results delivered by the test script during driving of the vehicle to be viewed at a later moment.

3. A system according to claim 1, further comprising a member configured to send said test results to a graphical user interface so as to be displayed to the driver of the vehicle.

4. A system according to claim 1, further comprising a plurality of said clients in the form of different executable test scripts each being a separate test step being configured to subscribe different said specific vehicle sub-system information and by carrying out said test assessment oracle thereof together forming a test case assessing if the vehicle functionality tested conforms to its requirements.

5. A system according to claim 1, wherein said server is associated with hardware and software for converting electrical signals taken from said bus into digital signals to be sent to said at least one client.

6. A system according to claim 1, wherein it is a testing tool included in one single mobile computer, such as a PC.

7. A method for testing functionalities of a distributed embedded system in the form of a vehicle while driving the vehicle having a message-based bus network topology to which different sub-systems of the vehicle are connected to publishing and reading information relating to the status of these sub-systems, the method comprising:
a) connecting a software server to said bus;
b) taking said sub-system information from the bus and sending it to said server, and interpreting this information as output from a timed automaton by said server;
c) making at least one client to subscribe from said server specific vehicle sub-system information to be used by a test assessment oracle for assessing a particular function or sub-function of the vehicle;
d) updating said client of the change of said specific vehicle sub-system information;
e) initiating said test assessment oracle to make an assessment of said particular function or sub-function of the vehicle upon said updating of a said specific vehicle sub-system information subscribed; and
f) delivering a test result by giving a final verdict of said particular function or sub-function of the vehicle.

8. A method according to claim 7, further comprising step g) of storing test results delivered during driving of the vehicle to be viewed at a later moment.

9. A method according to claim 7, further comprising step h) of sending said test results to a graphical user interface and displaying it to the driver of the vehicle.

10. A method according to claim 7, wherein step c) a plurality of said clients are made to subscribe from said server different said specific vehicles sub-system information and by carrying out said test assessment oracle thereof forming a separate test step of a test case assessing if the vehicle functionality tested conforms to its requirements.

11. A computer program product stored on a non-transitory computer-readable medium, said computer program product for testing functionalities of a distributed embedded system in the form of a vehicle while driving the vehicle having a message-based bus network topology to which different sub-systems of the vehicle are connected for publishing and reading information relating to the status of these sub-systems, wherein said computer program product comprising computer instructions to cause one or more computer processors to perform the following operations:
a) connecting a software server to said bus;
b) taking said sub-system information from the bus and sending it to said server, and interpreting this information as output from a timed automaton by said server;
c) making at least one client to subscribe from said server specific vehicle sub-system information to be used by a test assessment oracle for assessing a particular function or sub-function of the vehicle;
d) updating said client of the change of said specific vehicle sub-system information;
e) initiating said test assessment oracle to make an assessment of said particular function or sub-function of the vehicle upon said updating of a said specific vehicle sub-system information subscribed; and
f) delivering a test result by giving a final verdict of said particular function or sub-function of the vehicle.

12. (canceled)

13. A computer program product according to claim 11, further comprising computer instructions to cause one or more computer processors to perform the operation of g) of storing test results delivered during driving of the vehicle to be viewed at a later moment.

14. A computer program product according to claim 11, further comprising computer instructions to cause one or more computer processors to perform the operation of h) of sending said test results to a graphical user interface and displaying it to the driver of the vehicle.

15. A computer program product according to claim 11, wherein in operation c) a plurality of said clients are made to subscribe from said server different said specific vehicles sub-system information and by carrying out said test assessment oracle thereof forming a separate test step of a test case assessing if the vehicle functionality tested conforms to its requirements.
